(19) United States
(12) Patent Application Publication
(10) Pub. No.: US 2025/0363652 A1
(43) Pub. Date: Nov. 27, 2025

(54) SMART DEVICE FOR ESTIMATION OF TRAILER CHARACTERISTICS

(71) Applicant: Ford Global Technologies, LLC, Dearborn, MI (US)

(72) Inventors: Mohamed El-sawah, Canton, MI (US); Roger Arnold Trombley, Ann Arbor, MI (US); Keenan Kurtz, Royal Oak, MI (US); Vainatey Kulkarni, Windsor (CA); Robert Bell, New Hudson, MI (US)

(73) Assignee: Ford Global Technologies, LLC, Dearborn, MI (US)

(21) Appl. No.: 18/672,731

(22) Filed: May 23, 2024

(51) Int. Cl. G06T 7/60; G01S 7/4865; G01S 17/894; G06T 17/00; G06V 10/10; G06V 10/40; G06V 20/60

(52) U.S. Cl. CPC G06T 7/60; G01S 7/4865; G01S 17/894; G06T 17/00; G06V 10/40; G06V 20/60; G06T 2207/10028; G06V 10/17; G06V 2201/08

(57) ABSTRACT

A trailer measurement system includes a processor receiving a first image data set obtained from a first imager included in a portable electronic device external to the vehicle, identifying a vehicle and a trailer coupled with the vehicle in the first image data set, and identifying a reference feature having at least one known dimension in the first image data set. The processor then derives a scaling factor for the first image data set by comparing a size of the reference feature with respect to the first image data set and the at least one known dimension and uses the scaling factor to derive at least one trailer feature dimension from the trailer identified in the first image data set.

### FIELD OF THE DISCLOSURE

The present disclosure generally relates to a system for measuring various trailer dimensions. More specifically, the trailer measurement system uses a smart device to provide various data for use in determining the desire trailer measurements.

### BACKGROUND OF THE DISCLOSURE

There are many so-called advanced driver assistance systems (“ADAS”) that are intended to make trailering easier for a customer. These systems often require various measurements of the trailer to perform optimally and/or to utilize all available features. For example, in a trailer backup assistance (“TBA”) system, it is necessary to know where the rear axle of the trailer is in reference to the hitching point. For a system such as a blind spot information system (“BLIS”) with that includes a trailer tow function, the length and width of the trailer become important characteristics. For lane biasing, the width of the trailer is important. In the past, there were two primary methods of getting these measurements. The first is to ask the driver to measure the trailer with a tape measure. Given the heights of some trailers and unusual dimensions, this is not always easy to do accurately. Manually measuring the trailer dimensions can be time consuming and cumbersome, and it is a lengthy process of writing down measurements and then transferring them to the vehicle. Another method for measuring dimensions of a trailer is to measure key distances from on board sensors that will automate the process. This can be a convenient way of automating information-gathering for the customer.

### SUMMARY OF THE DISCLOSURE

According to one aspect of the present disclosure, a trailer measurement system includes a processor receiving a first image data set obtained from a first imager included in a portable electronic device external to the vehicle, identifying a vehicle and a trailer coupled with the vehicle in the first image data set, and identifying a reference feature having at least one known dimension in the first image data set. The processor then derives a scaling factor for the first image data set by comparing a size of the reference feature with respect to the first image data set and the at least one known dimension and uses the scaling factor to derive at least one trailer feature dimension from the trailer identified in the first image data set.

Embodiments of the first aspect of the invention can include any one or a combination of the following features:
the reference feature can be one of a bumper height, a wheel size, or a quarter panel length.
the at least one trailer feature dimension can be one of a distance between a hitching point of the trailer and an axle of the trailer, a length of the trailer, or a width of the trailer.
the portable electronic device can be a mobile telephone, the first imager can comprise a camera included in the mobile telephone, and the image data set can comprise visual image data received from the camera.
the image data set can comprise the visual image data in the form of a plurality of images including the vehicle and trailer from a corresponding plurality of locations surrounding the vehicle and the trailer, and prior to identifying the reference feature, the processor can use a photogrammetry process to construct the first image data set into a three-dimensional model of the vehicle and trailer.
the plurality of images can be photographs collectively received as the first data set.
the plurality of images can be selected ones of still frames images of a video received as the first data set.
the trailer measurement system can further include a lidar sensor, the processor can receive three-dimensional point-location data from the lidar sensor and uses the three-dimensional point location data, in combination with the first image data set in identifying the reference feature, derive the scaling factor, and derive the at least one trailer feature dimension.
the trailer measurement system can further include a mobile processor running a program that transmits the first image data set from a memory of the portable electronic device to the first processor.
the program can direct a user through a sequence of steps to capture the plurality of images using the camera of the portable electronic device.
the program can further cause the portable electronic device to obtain the three-dimensional point-location data from the lidar sensor included in the portable electronic device in correlation with the first image data set and transmit the first data set and the three dimensional point location data from a memory of the portable electronic device to the first processor.

According to another aspect of the present disclosure, a trailer measurement system includes a first processor receiving a plurality of images including a vehicle a trailer from a corresponding plurality of locations surrounding the vehicle and the trailer as a first visual image data set, the plurality of images being obtained from a camera included in a portable electronic device external to the vehicle. Using a photogrammetry process, the processor constructs the first image data set into a three-dimensional model of the vehicle and trailer. The processor identifies a vehicle and a trailer coupled with the vehicle in the three-dimensional model of the vehicle and trailer, identifies a reference feature having at least one known dimension in the three-dimensional model of the vehicle and trailer, and derives at least one trailer feature dimension of the trailer identified in the first image data set, including using the three-dimensional model of the vehicle and trailer to scale the first image data set based on the known dimension of the reference feature, the at least one trailer feature dimension being measured in at least the scaled first image data set.

According to another aspect of the present disclosure, a trailer measurement system includes a processor receiving a first image data set obtained from a first imager included in a portable electronic device external to the vehicle and receives three-dimensional point-location data from a lidar sensor included in the portable electronic device. The processor also identifies a vehicle and a trailer coupled with the vehicle in the first image data set, identifies a reference feature having at least one known dimension in the first image data set, and derives at least one trailer feature dimension from the trailer identified in the first image data set including using the first image data set in combination with the three-dimensional point-location data to scale the first image data set based on the known dimension of the reference feature, the at least one trailer feature dimension being measured in at least the scaled first image data set.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of an example trailer with various dimensions for measurement using a system according to the disclosure;

FIG. 2 is a side view of the example trailer of FIG. 1 shown in connection with a vehicle including reference features for use by the present system;

FIG. 3 is a perspective view showing the use of a smartphone in connection with the present system for measuring various trailer dimensions;

FIG. 4 is a schematic view of the system according to the disclosure; and

FIG. 5 is a flowchart showing steps in a method for measuring trailer dimensions using the disclosed system.

### DETAILED DESCRIPTION OF THE PREFERRED EMBODIMENTS

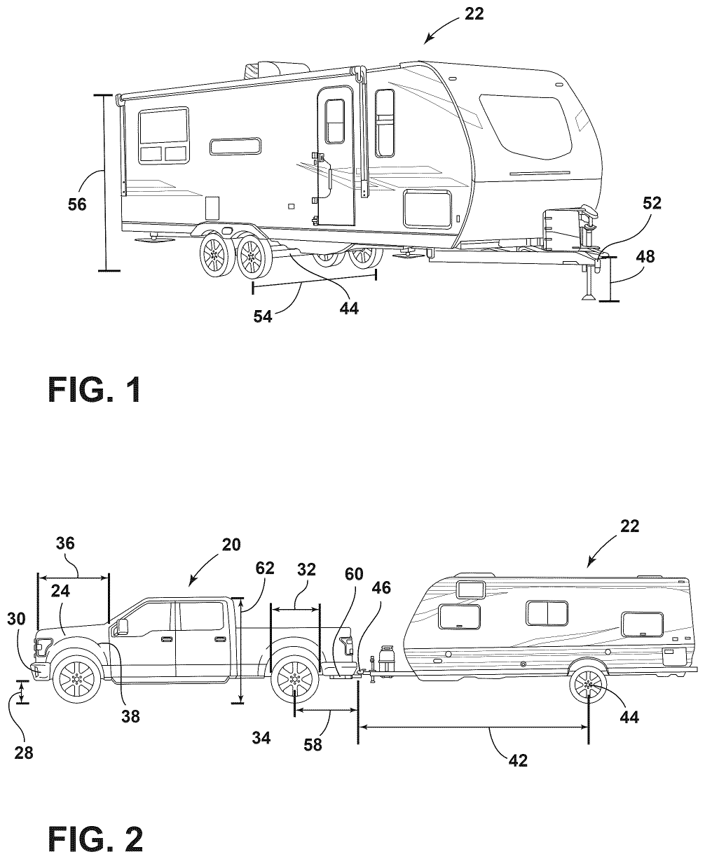

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

Ordinal modifiers (i.e., “first”, “second”, etc.) may be used to distinguish between various structures of the disclosed transportation rack in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIG. 1, reference numeral 10 generally designates a trailer measurement system. Trailer measurement system 10 includes a processor 12 receiving a first image data set 14 obtained from a first imager 16 included in a portable electronic device 18 external to a vehicle 20, identifying the vehicle 20 and a trailer 22 coupled with the vehicle 20 in the first image data set 14, and identifying a reference feature 24 having at least one known dimension Dₖ in the first image data set 14. The processor 12 then derives a scaling factor for the first image data set 14 by comparing a size of the reference feature 24 with respect to the first image data set 14 and the at least one known dimension Dₖ and uses the scaling factor to derive at least one trailer feature dimension Dₜ from the trailer 22 identified in the first image data set 14.

As mentioned above, there are many so-called advanced driver assistance systems (“ADAS”) that are intended to make trailering easier for a customer. These systems often require various measurements of the trailer to perform optimally and/or to utilize all available features. For example, in a trailer backup assistance (“TBA”) system, it is necessary to know where the rear axle of the trailer is in reference to the hitching point. For a system such as a blind spot information system (“BLIS”) with that includes a trailer tow function, the length of the trailer becomes an important characteristic. For lane biasing, the width of the trailer is important. In the past, there were two primary methods of getting these measurements. The present system leverages the increasingly advanced imagers and sensors in a smartphone to accurately gather the needed dimensional information with reduced effort, or opportunities for error, by the user. Notably, it is rare that a user will not have, or have access to, a smartphone or other smart device with an advanced mobile processor for running an application of the type, and configured for carrying out the functionality, discussed herein, as well as various sensors that can be used to gather information for making vehicle and trailer measurements with acceptable accuracy. In fact, many vehicle owners already utilize a smartphone application that can communicate with their vehicle, either using Bluetooth, mobile networking, or direct WiFi connections, for the control of various vehicle functions (door locks, remote start, etc.) and can assist with various vehicle ownership and management tasks. An example of such an application is the FORDPass® application available from the Ford Motor Company of Dearborn, MI. In one example, the present system 10 can utilize a modified or augmented version of such an application. In this respect, the processor 12 can be configured to communicate with the application 26 on the portable electronic device 18 and can include programming to interoperate with the portable electronic device 18 application 26, as discussed further below.

With reference to FIG. 2, the present system 10 can use a known dimension of a feature of the vehicle 20 (i.e., the reference feature 24) to determine the scale by which to measure the various trailer 22 features of interest to system 10 in the image data set 14. In various implementations, the reference feature 24 can be one of a height 28 of the bumper 30, a diameter 32 of one of the vehicle 20 wheels 34 size, or a length 36 of a vehicle panel, such as quarter panel 38. Other easily identifiable features with known lengths can be used. Additionally, multiple ones of such features can be used with the resulting scaling factor being averaged or checked. Still further, different reference features 24 can be used with different vehicles, depending on the geometry of such features in the specific implementations thereof on vehicle 20, or the specific feature 24 that is best identifiable (e.g., given the lighting or weather conditions, viewing angle, etc.) in the first image data set 14 can be selected in real time by processor 12. Additionally or alternatively, a measurement gauge in the form of an elongate article (e.g., a plastic block, stick, or the like) that can be labeled or printed in a way to be identifiable by system 10 can be placed in near the trailer 22 to act as the reference feature 24.

Once the reference features 24 has been identified (including, optionally, after selection), the processor 12 determines the size of the reference feature 24 in the first image data set 14, which can be measured, for example, in the number of pixels from a specified point or edge on the reference feature 24 to another specified point. The size of the reference feature 24 in the image is then compared to the known size of the reference feature 24 with respect to the actual vehicle 20 to determine the scaling factor of the first image data set 14 to the vehicle and/or the real-world scene that the first image data 14 set depicts. In one example, the scaling factor can be in terms of the number of image pixels per real-world inches (or cm, mm, etc.). This scaling factor can then be used to determine the relevant dimensions of the trailer 22 by determining the pixel-based dimensions of such feature and then converting them to real-world dimensions using the scaling factor. In additional aspects, a database of trailers may be available to the system 10 (e.g. on the cloud and accessible via an internet connection or stored in memory associated with the smartphone 18 of the vehicle 20) that can include a number of trailer images and associated measurements. The system 10 can use image recognition to match the identified trailer 22 in the image data 14 with a trailer image in the database and associate the relevant measurements with the trailer 22. In this respect, the scaling factor can be used as additional information to make or confirm a database identification, for example. The image recognition can be based on trailer size or by reading an indication of a trailer type from the sidewall of the trailer 22. Various types of image processing techniques can be used to identify both the reference feature(s) 24, as well as the measured features discussed below and the vehicle and trailer, overall. Such image processing techniques can be included in the programming of the processor 12 including in a specific program or application that executes the present measurement process and stored in memory 40 associated with, or otherwise accessible by the processor 12 and can include edge detect, corner detect, texture analysis, feature extraction, or various combinations thereof. Such analysis can further be carried out or augmented by various machine learning techniques, including those utilizing various neural networks and/or computer vision processes that can be included in the programming or accessible to the processor 12, for example, via the internet.

By the technique described herein, the system 10 can obtain the following measurements:
The distance 42 between the trailer 22 rear axle 44 (or the center of multiple rear axles) to the hitch point 46 between the trailer 22 and the vehicle 20;
The height 48 of the tongue 52 of the trailer 22;
The overall width 54 and length 55 of the trailer 22;
The overall height 56 of the trailer 22, including any load that extends above to the top of the trailer 22;
The length 58 of the draw bar 60;
The total height 62 of the vehicle 20, including the additional height of any aftermarket fixtures, such as lights, racks, or the like; and
The size (width and/or height) of the vehicle 20 tail lights 63 or rear window opening 65; and
The distance 67 from the top of the wheel 69 well to the top 71 of vehicle 20 or truck bed side 73.
   It is to be appreciated that the above list is provided by way of example and that additional or alternative measurements may be made depending on the use of such measurements and the overall vehicle 20 capabilities. In one aspect, the actual dimensions for the above features can be associated with the vehicle identification number (“VIN”) of the vehicle 20, which can be read in the image data 14, upon appropriate positioning of the smartphone 18.

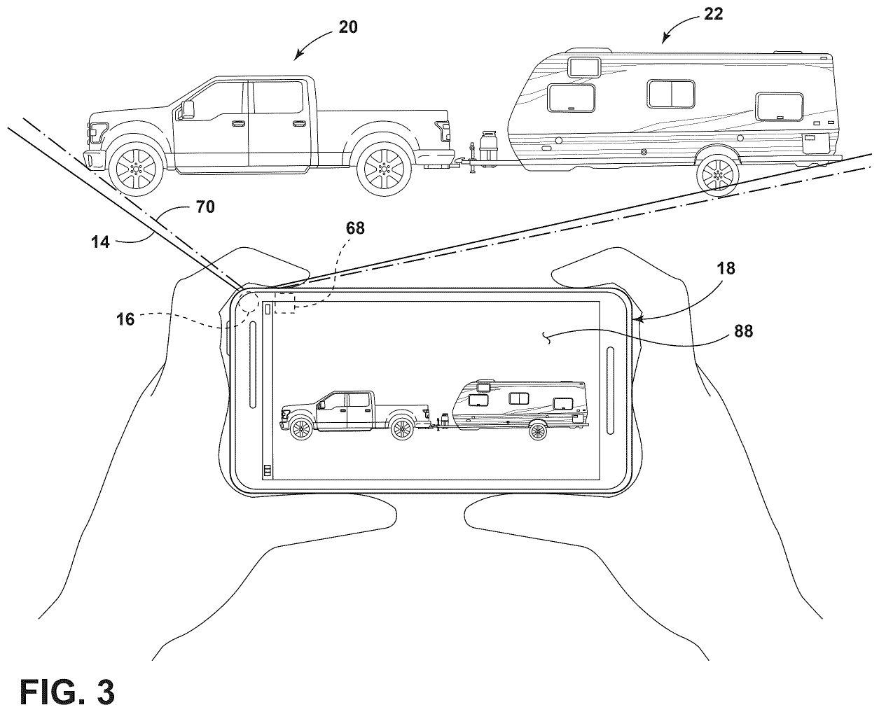

As shown in FIG. 3, and as discussed above, the portable electronic device 18 can be a mobile telephone. In this implementation, the imager 16, referenced above, can be the camera (also referenced using numeral 16) included in the mobile telephone (also referenced with numeral 18). In connection with the use of the camera 16, the first image data set 14 can comprise visual image data received from the camera 16, including by way of the particular sensor used in connection therewith. Additionally, most smartphones, including the type contemplated as being compatible with the present system 10, can record and associate additional data regarding the image. This additional information can be included with the first image data set 14 as “metadata” and can include information regarding the lens and/or sensor type, the aperture (if adjustable) and focal length used by the camera 16 in recording the image data set 14, along with location information (provided by the positioning device and/or related software or programming within the smartphone 18). This metadata can be transmitted by the smartphone 18 to the processor 12, including by wireless communication module 64, as a part of the first image data set 14. In this manner, the camera 16 characteristics can be considered when making the above-described image-based measurements for accuracy. In one respect, this can be done by accounting for the camera 16 characteristics as an additional step or function of the algorithm that uses the above-described scaling factor. In a further aspect, the vehicle control module 72 can be configured to allow the smartphone 18 to operate through the application 26 to function as a key to unlock and/or start the vehicle 20. In certain implementations of such functionality, the vehicle can include a plurality of ultra-wide band (“UWB”) anchors that communicate with the smartphone 18 for the purpose of determine the position of the smartphone 18 in and around the vehicle for the general purpose of establishing a minimum distance from the vehicle 20 for unlocking the vehicle 20 or for automatically unlocking or locking the vehicle as the driver approaches or leaves the vehicle 20. These features and the functionality provided thereby can be used to associate the specific location around the vehicle 20 at which any image was taken to increase the accuracy of the measurements obtained using the image data 14 set. Using the distance from the smartphone 18 to the vehicle 20 can be used to determine the distance from the trailer 22 for use with the image processing and other methods in determining the trailer characteristics, as discussed herein.

In a specific implementation of the system 10 described herein, the first image data set 14 can comprise the visual image data from camera 16 in the form of a plurality of images including the vehicle 20 and trailer 22 from a corresponding plurality of locations surrounding the vehicle 20 and the trailer 22. Prior to identifying the reference feature 24, the processor 12 can use a photogrammetry process to construct the first image data set 14 into a three-dimensional model of the vehicle 20 and trailer 22. The three-dimensional model can then be used for the measurement of the reference feature 24 and the subsequent measurement of the various trailer 22 characteristics. The use of the three-dimensional model can help account for the perspective shortening and/or distortion that can occur in a single image and for accuracy by the addition of information (i.e., additional images).

Photogrammetry is a technique that uses photographic images to make measurements. The process involves capturing a series of images of an object from different points or angles with the images including some common features such that they partially “overlap”. In various examples, the images can include still photographs or can be still frames of a video. These images are then processed using specialized software or programming within a larger software application or program. The program uses the overlapping images to triangulate points and create surfaces. This allows for the creation of reasonably accurate 2D or 3D models. In some aspects, the accuracy of the data collected may be relative to the quality of the images. Therefore, it may be beneficial to ensure high resolution and proper overlap of the images. In one aspect the software or programming used by processor 12 in connection with the present system 10 can guide the user through a picture-taking process that is intended to have the various images overlap. Additionally, such software or programming can confirm proper image resolution prior to moving to a subsequent image instruction. The points for triangulation in photogrammetry are identified through a process known as point matching. This process operates by first identifying common points in the overlapping images. These common points are known as tie points, and they represent the same location in adjacent images. Subsequently light rays corresponding with the points are defined. Specifically, each tie point defines a light ray in 3-D space that starts at the camera 16 and extends to the real object. By defining multiple (e.g., three or more) light rays associated with each tie point, the points can be triangulated in space. As discussed above, the first image data set 14 can include metadata associated with each separate image, with the utilized software taking into account the camera 16 characteristics such as focal length, pixel size, lens distortion to calibrate the geometric intersection of the light rays, as communicated in the metadata. A technique called bundle adjustment is used for triangulation and can adjust the photos simultaneously to create an intersection of all light rays at each pass point and ground control points. This, in turn, solves the unknown quantities consisting of X, Y, and Z object space coordinates. These coordinates are then used to construct the desired three-dimensional model.

In an alternative implementation, the application 26 used to collect the image data 14 on the smartphone 18 can carry out the pohotogrammetry process, including by leveraging software within the operating system of the smartphone 18 with such capability, if present. The first image data set 14 can then be communicated to the processor 12 in the form of the described three-dimensional model. As mentioned, the plurality of images can be photographs collectively received as the first data set 14, the photographs being taken at various intermediate locations around the entirety of the vehicle 20 and trailer 22. Alternatively, the plurality of images can be selected ones of still frames images of a video received as the first data set 14. As can be appreciated, a video is a sequence of frames or still images captured and played back at a specified frame rate. In this manner, the mobile application 26 or programming of processor 12 can use the still frame images from a video taken by the user in walking around the vehicle 20 and trailer 22 (including at the direction of the mobile application) or the processor 12 can extract still images at predetermined intervals (e.g., every second, or approximately 60 frames) or can select images that correspond with desired viewpoints, with the desired overlap.

As mentioned above, once the three-dimensional model has been generated, the processor 12 derives at least one trailer feature dimension of the trailer 22 identified in the first image data set 14 (including one or more of the specific features listed above). In one aspect, this involves using the three-dimensional model of the vehicle 20 and trailer 22 to scale the first image data set 14 based on the known dimension of the reference feature 24. Subsequently, the desired trailer feature dimension(s) is(are) measured in at least the first image data set 14 according to the derived scale.

Phones are also increasingly likely to be equipped with Light Detection and Ranging “LiDAR” sensors that can be used to augment the camera-based results discussed above and to provide more accuracy. In general, LiDAR uses laser pulses (infrared light) to measure distances and create 3D models of objects and environments. Unlike radar, which uses radio waves, LiDAR operates on a smaller scale and may provide accurate measurements over short distances. When a LiDAR sensor emits laser light, it bounces off objects in the environment. By measuring the time that it takes for these pulses to return, the sensor calculates distances between the emitter and the object of which the light pulse bounces. Notably, smartphones that incorporate augmented reality (“AR”) experiences may use LiDAR data to enhance interactions with virtual objects. In particular, smartphones can use the LiDAR data to better understand the environment, with the goal of making AR interactions smoother and more accurate. In this manner, a smartphone 18 can create a field of points that map out distances and dimensions in the environment. Such a field or “point cloud” consisting of three-dimensional point location data 70 can be superimposed over the first image data set 14 and can help to identify the key points in the first image data set 14 and/or to help in measuring both the reference feature 24 and the desired features of trailer 22.

In one aspect, the LiDAR data can be used in connection with the photogrammetry process discussed above to build a more accurate three-dimensional model of the vehicle 20 and trailer 22. A smartphone application 26 can initially determine if the smartphone 18 includes a LiDAR sensor 68 and can collect and transmit LiDAR data, if available. In one implementation, the trailer measurement system 10 can include a LiDAR sensor by way of the above-described wireless communication with smartphone 18, and the processor 12 can receive three-dimensional point-location data 70 from the lidar sensor 68 and uses the three-dimensional point location data 70 in combination with the first image data set 14 in identifying the reference feature 24, deriving the scaling factor, and deriving the at least one trailer feature dimension. The processor 12 can derive the desired trailer feature dimension(s) from the trailer 22 identified in the first image data set 14, including by using the first image data 14 set in combination with the three-dimensional point-location data 70 to scale the first image data set 14 based on the known dimension of the reference feature 24, with the desired trailer feature dimension(s) being measured in at least the scaled first image data set 14.

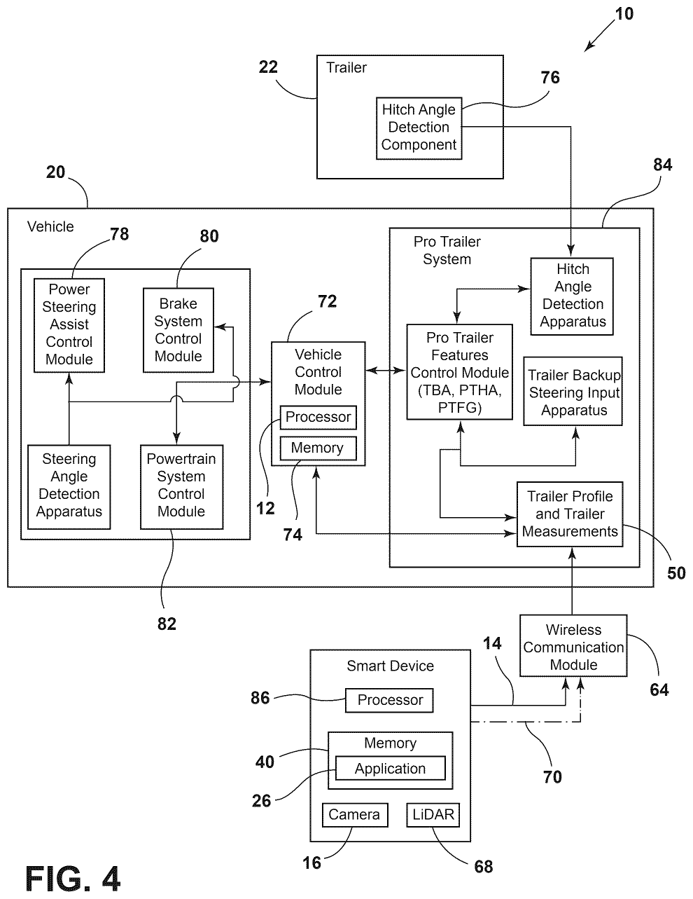

An example of the present system 10, including various optional components, is shown in FIG. 4. In one aspect, the system 10 includes the above-referenced processor 12 may be included a vehicle control-module or controller 72. When included in such a controller 72, the processor 12 can be a microprocessor that processes logic and routines stored in memory 74. In this respect, processor 12 can receive information from various sensors and vehicle systems, including a hitch angle detection system 76, a power assist steering control module 78, the vehicle brake control module 80, a powertrain control module 82, and other vehicle sensors and devices. In the illustrated example, the vehicle 20 further includes a trailer assist system 84 that can be leveraged by the processor 12 to generate vehicle steering information and commands as a function of all or a portion of the information received from the sensors. Thereafter, the vehicle steering information and commands may be provided to the power assist steering module 78 for affecting steering of the vehicle 20 to achieve a commanded path of travel for the combined vehicle 20 and trailer 22, as discussed further in U.S. Pat. Nos. 10,023,229; 9,714,051; and 9,840,278, the entire disclosures of which are incorporated by reference herein. It should be appreciated that the controller 72 may be a stand-alone dedicated controller or may be a shared controller integrated with other control functions, such as integrated with a vehicle sensor system (such as the steering angle detection apparatus 79), the power assist steering module 72, and other conceivable onboard or off-board vehicle control systems.

System 10 can be characterized as further including a mobile processor 86 within the smartphone 18 with which the processor 12 is connected by way of the wireless communication module 64. As discussed above, the mobile processor 86 can run the program or application 26 (which can be stored in memory 40 associated with the smartphone 18) that transmits the first image data set 14 from the memory 40 of the smartphone 18 to the processor 12. Once in the vehicle 20, the first image data set 14 can be used to obtain the desired trailer measurements, which can be stored in the vehicle memory 40 in a record 50 for the particular trailer 22 and then utilized for various ADAS features, including the trailer backup assist feature shown in the system of FIG. 4, as well as other features, examples of which are given above.

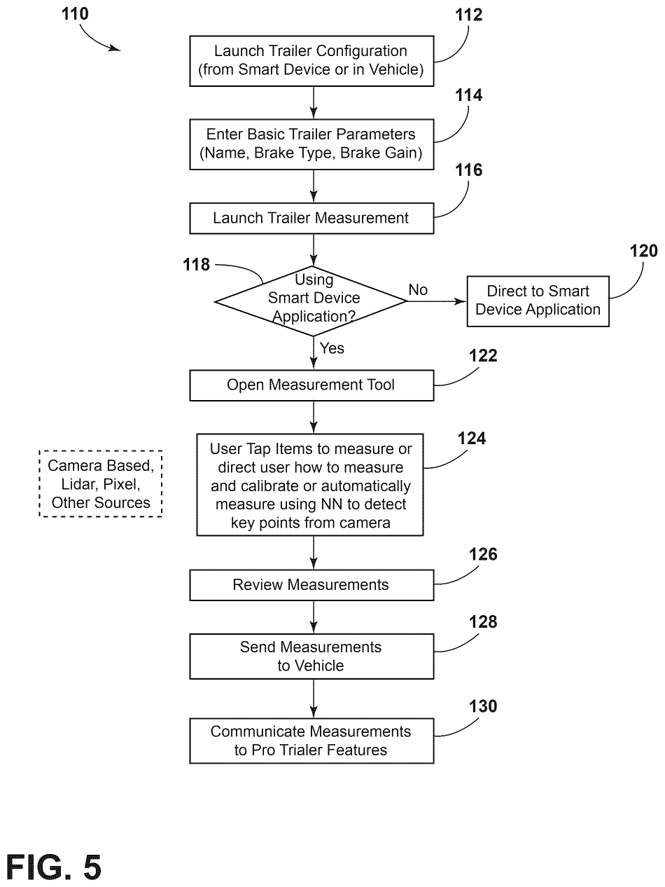

Turning to FIG. 5, an example of a process for obtaining the trailer measurements discussed above is illustrated. In particular, the process includes the use of a smartphone 18 running the above-describe application 26, which may guide the user through certain steps of the process. Initially, the process 110 may be launched using the smartphone 18 or using an in-vehicle human-machine interface (“HMI”). The user is then guided to entire basic trailer information (a trailer name, brake type and, optionally, brake gain) either by way of the smartphone 18 or the HMI, in step 112. Once such information is entered, the measurement process is initiated 114. If the process is launched by the HMI (step 116), the user is prompted to launch the mobile application 26 via a compatible, connected smartphone 18 (step 118). Once the application 26 is opened, the measurement mode can be entered, either automatically on direction of the processor upon establishment of communication, or by the user (step 120). The application 26 can then guide the user (step 122) to take one or more images from specified points of view so that the system 10 can obtain the necessary information to make the desired measurements, as discussed above. This guidance can be directed, at least in part, using a neural network to assess the point of view for clarity of features and the angle, perspective, or alignment of the vehicle 20 and trailer 22. In a further variation, the application 26 can list features for measurement, with the user tapping on the features in the image via the smartphone 18 touchscreen 88, with the touch point being recorded and associated with the resulting image data 14 and/or lidar data 70 for use by the processor 12 in identifying or confirming the identification of the particular feature to be measured. As discussed above, in variations where multiple images or a video are used to construct a three-dimensional model, the smartphone 18 can similarly guide this process using overlays and/or onscreen instructions. In particular, in an implementation, the application 26 can cause the smartphone 18 to obtain the three-dimensional point-location data 70 from the lidar sensor 68 in correlation with the image(s) comprising the first image data set 14 and transmit the first image data set 14 and the three-dimensional point location data 70 from the memory 74 of the portable electronic device 18 to the first processor 12.

The application 26 can then confirm that the necessary images and information have been obtained (step 124) before transmitting the first image data set 14 and, optionally, the associated metadata and point location data 70 to the processor 12 via the ireless communication module 64 (step 126). When this information is received, the processor 12 can make the desired measurements using at least the first image data set 14 according to one or more of the specific processes discussed above.

It is to be understood that variations and modifications can be made on the aforementioned structure without departing from the concepts of the present disclosure, and further it is to be understood that such concepts are intended to be covered by the following claims unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A trailer measurement system, comprising:
a processor:
receiving a first image data set obtained from a first imager included in a portable electronic device external to a vehicle;
identifying the vehicle and a trailer coupled with the vehicle in the first image data set; and
identifying a reference feature having at least one known dimension in the first image data set;
deriving a scaling factor for the first image data set by comparing a size of the reference feature with respect to the first image data and the at least one known dimension; and
using the scaling factor to derive at least one trailer feature dimension from the trailer identified in the first image data set.

2. The trailer measurement system of claim 1, wherein the reference feature is one of a taillight width or height, a rear window opening width or height, a distance from a wheel well to an adjacent top portion of the vehicle, or a quarter panel length.

3. The trailer measurement system of claim 1, wherein the at least one trailer feature dimension is one of a distance between a hitching point of the trailer and an axle of the trailer, a length of the trailer, or a width of the trailer.

4. The trailer measurement system of claim 1, wherein:
the portable electronic device is a mobile telephone;
the first imager comprises a camera included in the mobile telephone; and
the first image data set comprises visual image data received from the camera.

5. The trailer measurement system of claim 4, wherein:
the first image data set comprises the visual image data as a plurality of images including the vehicle and trailer from a corresponding plurality of locations surrounding the vehicle and the trailer; and
prior to identifying the reference feature, the processor uses a photogrammetry process to construct the first image data set into a three-dimensional model of the vehicle and trailer.

6. The trailer measurement system of claim 5, wherein the plurality of images are photographs collectively received as the first image data set.

7. The trailer measurement system of claim 5, wherein the plurality of images are selected ones of still frames images of a video received as the first image data set.

8. The trailer measurement system of claim 1, further including a lidar sensor, wherein:
the processor receives a three-dimensional point-location data set from the lidar sensor and uses the three-dimensional point location data, in combination with the first image data set in identifying the reference feature, deriving the scaling factor, and deriving the at least one trailer feature dimension.

9. A trailer measurement system, comprising:
a first processor:
receiving a plurality of images including a vehicle and a trailer from a corresponding plurality of locations surrounding the vehicle and the trailer as a first visual image data set, the plurality of images being obtained from a camera included in a portable electronic device external to the vehicle;
using a photogrammetry process to construct the first visual image data set into a three-dimensional model of the vehicle and trailer;
identifying a vehicle and a trailer coupled with the vehicle in the three-dimensional model of the vehicle and trailer; and
identifying a reference feature having at least one known dimension in the three-dimensional model of the vehicle and trailer; and
deriving at least one trailer feature dimension of the trailer identified in the first image data set, including using the three-dimensional model of the vehicle and trailer to scale the first image data set based on the known dimension of the reference feature, the at least one trailer feature dimension being measured in at least the scaled first image data set.

10. The trailer measurement system of claim 9, wherein the plurality of images are photographs collectively received as the first visual image data set.

11. The trailer measurement system of claim 9, wherein the plurality of images are selected ones of still frame images of a video received as the first visual image data set.

12. The trailer measurement system of claim 9, further including a mobile processor running a program that transmits the first visual image data set from a memory of the portable electronic device to the first processor.

13. The trailer measurement system of claim 12, wherein the program directs a user through a sequence of steps to capture the plurality of images using the camera of the portable electronic device.

14. The trailer measurement system of claim 9, wherein the reference feature is one of a bumper height, a wheel size, or a quarter panel length.

15. The trailer measurement system of claim 9, wherein the at least one trailer feature dimension is one of a distance between a hitching point of the trailer and an axle of the trailer, a length of the trailer, or a width of the trailer.

16. A trailer measurement system for use in connection with a vehicle, comprising:
a first processor:
receiving a first image data set obtained from a first imager included in a portable electronic device external to the vehicle;
receiving three-dimensional point-location data from a lidar sensor included in the portable electronic device;
identifying a vehicle and a trailer coupled with the vehicle in the first image data set;
identifying a reference feature having at least one known dimension in the first image data set; and
deriving at least one trailer feature dimension from the trailer identified in the first image data set including using the first image data set in combination with the three-dimensional point-location data to scale the first image data set based on the known dimension of the reference feature, the at least one trailer feature dimension being measured in at least the scaled first image data set.

17. The trailer measurement system of claim 16, wherein the processor further uses the three-dimensional point-location data in measuring the at least one trailer feature dimension.

18. The trailer measurement system of claim 16, further including a mobile processor running a program that:
directs a user to capture the first image data set using the first imager of the portable electronic device;
causes the portable electronic device to obtain the three-dimensional point-location data from the lidar sensor included in the portable electronic device in correlation with the first image data set; and
transmits the first image data set and the three-dimensional point location data from a memory of the portable electronic device to the first processor.

19. The trailer measurement system of claim 16, wherein the reference feature is one of a bumper height, a wheel size, or a quarter panel length.

20. The trailer measurement system of claim 16, wherein the at least one trailer feature dimension is one of a distance between a hitching point of the trailer and an axle of the trailer, a length of the trailer, or a width of the trailer.
